(19) United States
(12) Patent Application Publication
(10) Pub. No.: US 2015/0128271 A1
(43) Pub. Date: May 7, 2015

(54) APPARATUS AND METHOD FOR COLLECTING NETWORK DATA TRAFFIC

(71) Applicant: ELECTRONICS AND TELECOMMUNICATIONS RESEARCH INSTITUTE, Daejeon (KR)

(72) Inventors: In-Cheol Shin, Daejeon (KR); Yu-Seok Jeon, Daejeon (KR); Sin-Kyu Kim, Daejeon (KR); Jung-Taek Seo, Daejeon (KR)

(21) Appl. No.: 14/401,364

(22) PCT Filed: May 21, 2013
(86) PCT No.: PCT/KR2013/004445

§ 371 Date: Nov. 14, 2014

(30) Foreign Application Priority Data
May 22, 2012 (KR) 10-2012-0053989
Feb. 6, 2013 (KR) 10-2013-0013138

(51) Int. Cl. H04L 29/06; H04L 12/26; G06F 17/30

(52) U.S. Cl. CPC H04L 63/1416; G06F 17/30327; H04L 43/08
USPC 726/23

(57) ABSTRACT

The present invention relates to an apparatus and method for collecting network data traffic. The apparatus for collecting network data traffic includes a graph creation unit, an initialization unit, an edge selection unit, a reconstruction unit, an algorithm application unit and a traffic collection route provision unit. The reconstruction unit converts the selected edge into an inactive edge and connects the inactive edge to two nodes, so that the reconstruction unit reconstructs the tree structure. The algorithm application unit applies a minimal spanning tree algorithm to the reconstructed tree structure. The traffic collection route provision unit eliminates a leaf node and a leaf edge from the tree structure to which the minimal spanning tree algorithm has been applied, and generates a monitoring tree for providing a traffic collection route minimizing a total weight of the edges.

### TECHNICAL FIELD

The present invention relates, in general, to an apparatus and method for collecting network data traffic and, more particularly, to an apparatus and method for collecting network data traffic, which safely collect network data traffic and promptly transfer the network data traffic to an Intrusion Detection System (IDS), without causing a hidden terminal problem.

### BACKGROUND ART

A smart meter, which plays an important role in an Advanced Metering Infrastructure (AMI) that has evolved from a conventional unidirectional Automatic Meter Reading (AMR) system and that enables bidirectional data communication between consumers and a power company, may be regarded as a device likely to be targeted and likely to sustain the most damage in the event of a cyber attack.

In addition, a mesh network composed of smart meters is a target of attack by various malicious codes because it is located at a connective vertex with an external public network. Therefore, the mesh network composed of smart meters necessarily requires the installation of an Intrusion Detection System (IDS) so that it can be safely protected against external attacks.

However, an IDS installed in the mesh network composed of smart meters cannot easily be kept separate from a hidden terminal problem, and so an overlapping phenomenon occurs during a procedure for collecting network data traffic, thus causing problems of efficiency and reliability of the IDS. In the mesh network composed of smart meters, a case where two smart meters, located at a distance at which it is impossible to perform direct wireless communication, and a data collector, installed at a location at which data transmitted from the individual smart meters can be received, are provided is described by way of example. Since the two smart meters cannot mutually communicate with each other, they can simultaneously transmit data to the data collector. However, in the data collector, pieces of data simultaneously transmitted from the two smart meters may overlap each other, thus making it impossible to exactly collect data.

In order to avoid such data overlapping, a traffic monitoring sensor for collecting traffic data may be installed in the narrow place of a network, as disclosed in Korean Unexamined Patent Publication No. 10-2010-0069410, but this may cause an excessive economic burden. Further, since a monitoring sensor is mainly installed at a fixed location, there are problems in that an attacker may easily access the monitoring sensor, and traffic data can be transferred to an IDS located a long distance away only when an additional communication infrastructure for the sensor is supported.

### DISCLOSURE

### Technical Problem

The present invention has been made keeping in mind the above problems, and an object of the present invention is to provide an apparatus and method for collecting network data traffic, which collect data traffic by configuring a monitoring tree for providing a traffic collection route that minimizes a total weight of edges without requiring an additional hardware device in a mesh network based on existing smart meters, thus safely and promptly transferring data traffic to an intrusion detection system located along distance away without causing data overlapping.

Another object of the present invention is to provide an apparatus and method for collecting network data traffic, in which a mesh network based on smart meters may be dynamically configured in various forms, thus preventing a procedure for collecting data traffic from being perceived from the outside of the mesh network.

### Technical Solution

An apparatus for collecting network data traffic according to the present invention to accomplish the above objects includes a graph creation unit for creating a graph in a form of a set of nodes and edges by using traffic collection units on a network as the nodes and using connection relations between the traffic collection units as the edges; an initialization unit for arranging the edges of the graph in ascending order of weights of the edges and initializing a tree structure of the nodes; an edge selection unit for selecting an edge having a minimum weight from among the arranged edges; a reconstruction unit for converting the selected edge into an inactive edge, and connecting the inactive edge to two nodes, thus reconstructing the tree structure; an algorithm application unit for applying a minimal spanning tree algorithm to the reconstructed tree structure; and a traffic collection route provision unit for eliminating a leaf node and a leaf edge from the tree structure to which the minimal spanning tree algorithm has been applied, and generating a monitoring tree for providing a traffic collection route minimizing a total weight of the edges.

Further, the weights of the edges may be values corresponding to distances between the traffic collection units.

Furthermore, the reconstruction unit may include a node connection determination unit for determining whether the two nodes are connected to other nodes through active edges; an edge elimination unit for, if the two nodes are connected to other nodes through the active edges, eliminating the active edges; a node conversion determination unit for determining whether an existing leaf node has been converted into an internal node due to the edge converted into the inactive edge; and an edge connection unit for, if the existing leaf node has been converted into the internal node, connecting the initialized nodes through active edges, and then reconstructing the tree structure into a tree structure having a maximum number of leaf edges.

Furthermore, the reconstruction unit may reconstruct the tree structure until all of the nodes are included in the tree structure.

Meanwhile, the traffic collection units may be classified into a first traffic collection unit corresponding to a leaf node of the tree structure and not belonging to the monitoring tree, and a second traffic collection unit corresponding to an internal node of the tree structure and belonging to the monitoring tree.

Furthermore, the total weight of the edges may not include a weight of the first traffic collection unit.

Furthermore, the total weight of the edges may include only a weight of the second traffic collection unit.

Furthermore, the second traffic collection unit may receive a communication request signal from the first traffic collection unit, collect data traffic, and transmit the data traffic to a management server through the traffic collection route.

Furthermore, the first traffic collection unit may include a communication request transmission unit for transmitting the communication request signal to the second traffic collection unit; a communication preparation unit for receiving a communication preparation signal from the second traffic collection unit; and a first traffic transmission unit for transmitting collected data traffic to the second traffic collection unit.

Furthermore, the second traffic collection unit may include a communication request reception unit for receiving the communication request signal from the first traffic collection unit; a communication preparation transmission unit for transmitting the communication preparation signal to the first traffic collection unit; a traffic reception unit for receiving the data traffic from the first traffic collection unit; and a second traffic transmission unit for collecting the received data traffic and transmitting the data traffic to the management server through the traffic collection route.

Meanwhile, each of the traffic collection unit may include a plurality of smart meters and the management server may be implemented as an intrusion detection server for analyzing the received data traffic and detecting an abnormal action.

A method for collecting network data traffic according to the present invention to accomplish the above objects includes creating, by a graph creation unit, a graph in a form of a set of nodes and edges by using traffic collection units on a network as the nodes and using connection relations between the traffic collection units as the edges; arranging, by an initialization unit, the edges of the graph in ascending order of weights of the edges and initializing a tree structure of the nodes; selecting, by an edge selection unit, an edge having a minimum weight from among the arranged edges; converting, by a reconstruction unit, the selected edge into an inactive edge, and connecting the inactive edge to two nodes, thus reconstructing the tree structure; applying, by an algorithm application unit, a minimal spanning tree algorithm to the reconstructed tree structure; and eliminating, by a traffic collection route provision unit, a leaf node and a leaf edge anti the tree structure to which the minimal spanning tree algorithm has been applied, and generating a monitoring tree for providing a traffic collection route minimizing a total weight of the edges.

Further, the weights of the edges may be values corresponding to distances between the traffic collection units.

Furthermore, reconstructing the tree structure may include determining whether the two nodes are connected to other nodes through active edges; if the two nodes are connected to other nodes through the active edges, eliminating the active edges; determining whether an existing leaf node has been converted into an internal node due to the edge converted into the inactive edge; and if the existing leaf node has been converted into the internal node, connecting the initialized nodes through active edges, and then reconstructing the tree structure into a tree structure having a maximum number of leaf edges.

Furthermore, reconstructing the tree structure may be repeated until all of the nodes are included in the tree structure.

Furthermore, the method may further include, after generating the monitoring tree, transmitting, by a first traffic collection unit, a communication request signal to a second traffic collection unit; receiving, by the second traffic collection unit, the communication request signal; transmitting, by the second traffic collection unit, a communication preparation signal to the first traffic collection unit; receiving, by the first traffic collection unit, the communication preparation signal; transmitting, by the first traffic collection unit, collected data traffic to the second traffic collection unit; and transmitting, by the second traffic collection unit, the received data traffic to a management server.

Furthermore, the first traffic collection unit may include traffic collection units corresponding to leaf nodes of the tree structure and not belonging to the monitoring tree, and the second traffic collection unit includes traffic collection units corresponding to internal nodes of the tree structure and belonging to the monitoring tree.

Furthermore, the total weight of the edges may not include a weight of the first traffic collection unit, and may include only a weight of the second traffic collection unit.

### Advantageous Effects

The apparatus and method for collecting network data traffic according to the present invention having the above configuration are advantageous in that data traffic is collected by configuring a monitoring tree for providing a traffic collection route that minimizes a total weight of edges without requiring an additional hardware device in a mesh network based on existing smart meters, so that data traffic can be safely and promptly transferred to an intrusion detection system located a long distance away without causing data overlapping, thus improving efficiency and reliability of the intrusion detection system.

Further, the present invention is advantageous in that a mesh network based on smart meters may be dynamically configured in various forms, so that an external attacker cannot perceive a procedure for collecting data traffic, thus improving the security of an intrusion detection system.

### DESCRIPTION OF DRAWINGS

FIG. 1 is a diagram showing a network structure according to an embodiment of the present invention;

FIG. 2 is a diagram showing the schematic configuration of an apparatus for collecting network data traffic according to an embodiment of the present invention;

FIG. 3 is a diagram showing the detailed configuration of a reconstruction unit employed in the apparatus for collecting network data traffic according to an embodiment of the present invention;

FIG. 4 is a diagram showing the detailed configuration of traffic collection units employed in the apparatus for collecting network data traffic according to an embodiment of the present invention;

FIG. 5 is a diagram showing the detailed configuration of a first traffic collection unit and a second traffic collection unit divided by the traffic collection unit of FIG. 4;

FIG. 6 is a flowchart showing a method for collecting network data traffic according to an embodiment of the present invention;

FIG. 7 is a flowchart showing a tree structure reconstruction method employed in the network data traffic collection method according to an embodiment of the present invention; and

FIG. 8 is a flowchart showing a communication method employed in the network data traffic collection method according to an embodiment of the present invention.

### BEST MODE

Hereinafter, preferred embodiments of the present invention will be described in detail with reference to the attached drawings so as to describe in detail the present invention to such an extent that those skilled in the art can easily implement the technical spirit of the present invention. Reference now should be made to the drawings, in which the same reference numerals are used throughout the different drawings to designate the same or similar components. In the following description, detailed descriptions of related known elements or functions that may unnecessarily make the gist of the present invention obscure will be omitted.

Hereinafter, an apparatus and method for collecting network data traffic according to embodiments of the present invention will be described in detail with reference to the attached drawings.

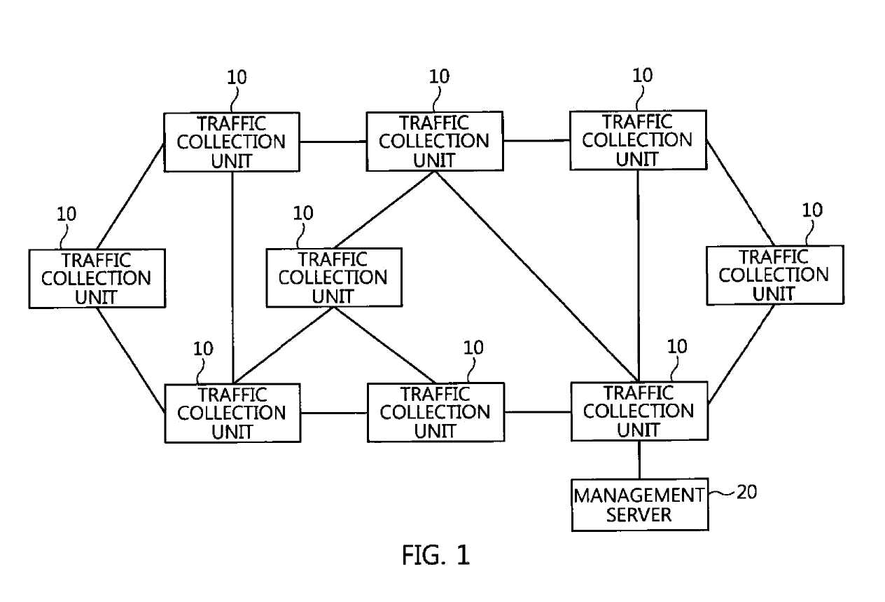

FIG. 1 is a diagram showing a network structure according to an embodiment of the present invention.

Referring to FIG. 1, a network according to the present invention is implemented as a mesh network (a wireless mesh network: WMN) including a plurality of traffic collection units 10 and a management server 20. In this case, the traffic collection units 10 of the present invention are implemented as smart meters, and the management server 20 may be implemented as an intrusion detection server for analyzing data traffic received from the smart meters and detecting an abnormal action. The mesh network denotes a network in which respective nodes on the network are present as independent routers. Since these nodes are connected to each other in the form of a mesh, communication can be performed via a connection to another node even if one node is disconnected. In the present invention, the traffic collection units 10 are represented by nodes, distances between the traffic collection units 10 are represented as edges, and a traffic collection mute is implemented using a tree structure, which has the traffic collection units for collecting data traffic and the management server 20 as vertices and which minimizes the total weight of the edges. In the present invention, such a tree structure is designated as a monitoring tree. Further, in the drawing, although the network is constructed as a network including one management server 20, it may be expanded to a network including two or more management servers 20.

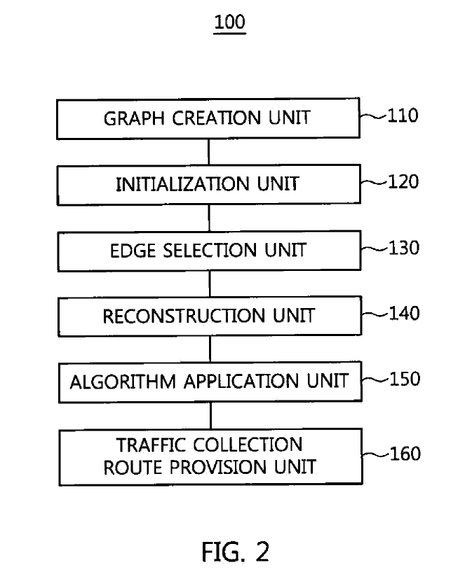

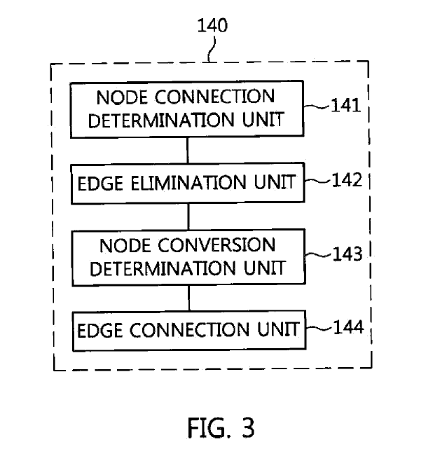

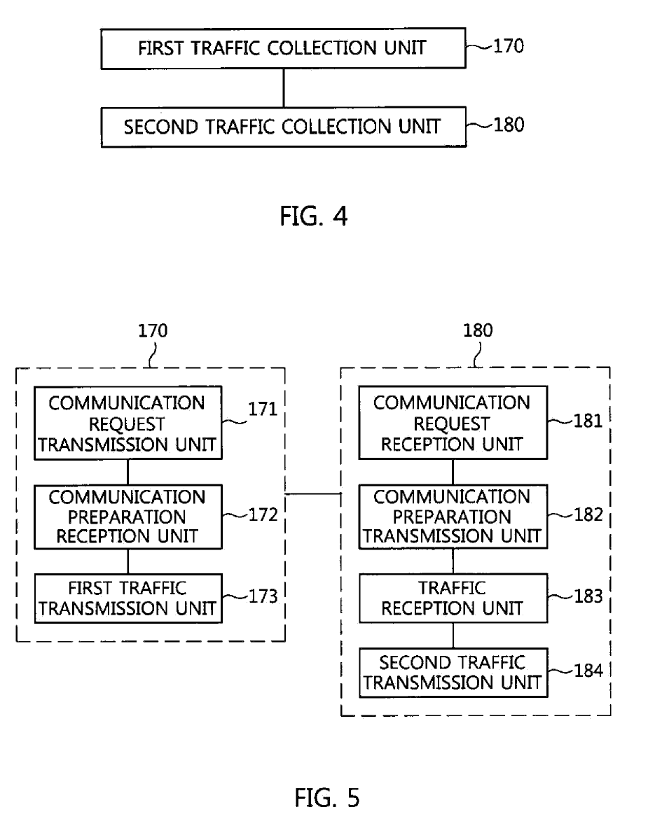

FIG. 2 is a diagram showing the schematic configuration of an apparatus for collecting network data traffic according to an embodiment of the present invention, FIG. 3 is a diagram showing the detailed configuration of a reconstruction unit employed in the apparatus for collecting network data traffic according to an embodiment of the present invention, FIG. 4 is a diagram showing the detailed configuration of traffic collection units employed in the apparatus for collecting network data traffic according to an embodiment of the present invention, and FIG. 5 is a diagram showing the detailed configuration of a first traffic collection unit and a second traffic collection unit divided by the traffic collection unit of FIG. 4.

Referring to FIG. 2, an apparatus 100 for collecting network data traffic according to the present invention may mainly include a graph creation unit 110, an initialization unit 120, an edge selection unit 130, a reconstruction unit 140, an algorithm application unit 150, and a traffic collection route provision unit 160.

The graph creation unit 110 creates a graph in the form of a set of nodes and edges by using the traffic collection units 10 as nodes and using connection relations between the traffic collection units 10 as edges. Here, the traffic collection units 10 are classified into first traffic collection units which do not belong to a monitoring tree, and second traffic collection units which belong to the monitoring tree, and these traffic collection units will be described in detail later with reference to FIG. 4.

The initialization unit 120 arranges the edges of the graph in ascending order of weights of the edges, and initializes the tree structure of the nodes. In this case, the weights are values corresponding to distances between the traffic collection units 10, and it means that edges having shorter distances have smaller weights.

The edge selection unit 130 selects an edge having a minimum weight from among the arranged edges.

The reconstruction unit 140 converts the selected edge into an inactive edge, and connects the inactive edge to two nodes, thus reconstructing the tree structure. In this case, the term “inactive edge” means an edge which does not perform data transmission.

For this, the reconstruction unit 140 includes a node connection determination unit 141 and an edge elimination unit 142, as shown in FIG. 3.

The node connection determination unit 141 determines whether two nodes are connected to other nodes through active edges. In this case, the term “active edge” denotes an activated edge so as to perform data transmission.

The edge elimination unit 142 eliminates the active edges when the two nodes are connected to other nodes through the active edges.

Internal nodes are generated through the active edges and, in this case, an additional operation for the internal nodes is required.

For this, the reconstruction unit 140 includes a node conversion determination unit 143 and an edge connection unit 144, as shown in FIG. 3.

The node conversion determination unit 143 determines whether an existing leaf node has been converted into an internal node due to the edge converted into the inactive edge. In this case, the term “leaf node” denotes a node having no successor node in a graph or a tree, that is, a terminated node. The term “internal node” denotes a node other than a leaf node in the graph or the tree.

The edge connection unit 144 is configured to, if the existing leaf node has been converted into the internal node, connect the initialized nodes through active edges, thus reconstructing the tree structure into a tree structure having a maximum number of leaf edges. This is repeated until all of the nodes are included in the reconstructed tree structure, and a monitoring tree, generated as a result of the repetition, may include circulation, and so the monitoring tree is finally changed to a tree shape by the algorithm application unit 150. Here, edges converted into inactive edges are expected to subsequently develop into internal nodes and must be minimized because they are finally included in the total weight of edges of the monitoring tree. Active edges are connected to leaf nodes, but they are edges which are not determined to subsequently develop into inactive edges, and must be maximized because the active edges are not included in the total weight of the edges of the monitoring tree.

The algorithm application unit 150 applies a minimal spanning tree algorithm to the reconstructed tree structure. In this case, representative schemes of the minimal spanning tree algorithm include a Prim's algorithm and a Kruskal's algorithm. The Prim's algorithm is a scheme for selecting a vertex and selecting a lowest cost vertex that is connected to the vertex, and the Kruskal's algorithm is a scheme for sequentially arranging all costs and selecting lowest cost edges. The present invention may utilize various schemes without being restricted by a specific scheme.

The traffic collection route provision unit 160 eliminates a leaf node and a leaf edge from the tree structure to which the minimal spanning tree algorithm has been applied, and then generates a monitoring tree for providing a traffic collection route that minimizes the total weight of edges.

In this case, the traffic collection units 10 may be classified into first traffic collection units 170 which do not belong to the nodes of the monitoring tree and second traffic collection units which belong to the nodes of the monitoring tree, as shown in FIG. 4. That is, the first traffic collection units 170 correspond to leaf nodes that are eliminated from the tree structure, and weights of the first traffic collection units 170 are not included in the total weight of edges. Further, the second traffic collection units 180 correspond to the internal nodes of the tree structure, and weights of the second traffic collection unit 180 are included in the total weight of edges.

In greater detail, the first traffic collection units 170 are implemented as traffic collection units which do not belong to the monitoring tree and are configured to transmit collected data traffic to the second traffic collection units 180. The second traffic collection units 180 are implemented as traffic collection units which belong to the monitoring tree and are configured to collect data traffic transmitted from the first traffic collection units 170 and transmit the data traffic to the management server 20.

A communication structure between each first traffic collection unit 170 and each second traffic collection unit 180 is shown in FIG. 5.

The first traffic collection unit 170 includes a communication request transmission unit 171, a communication preparation reception unit 172, and a first traffic transmission unit 173.

The communication request transmission unit 171 transmits a communication request signal to the second traffic collection unit 180.

The communication preparation reception unit 172 receives a communication preparation signal from the second traffic collection unit 180 that received the communication request signal.

The first traffic transmission unit 173 transmits the collected data traffic to the second traffic collection unit 180.

The second traffic collection unit 180 includes a communication request reception unit 181, a communication preparation transmission unit 182, a traffic reception unit 183, and a second traffic transmission unit 184.

The communication request reception unit 181 receives the communication request signal from the first traffic collection unit 170.

The communication preparation transmission unit 182 transmits the communication preparation signal to the first traffic collection unit 170, and then notifies the first traffic collection unit 170 that the communication preparation transmission unit 182 is collecting data traffic.

The traffic reception unit 183 receives data traffic from the first traffic collection unit 170.

The second traffic transmission unit 184 collects the received data traffic and transmits the data traffic to the management server 10 through a traffic collection route.

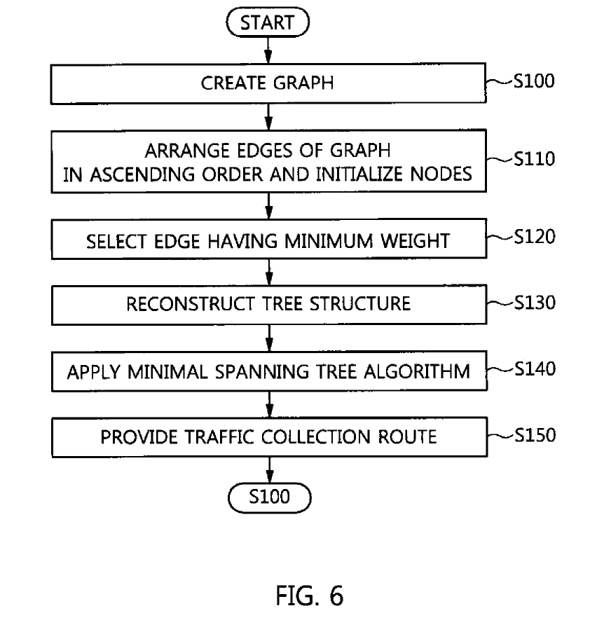

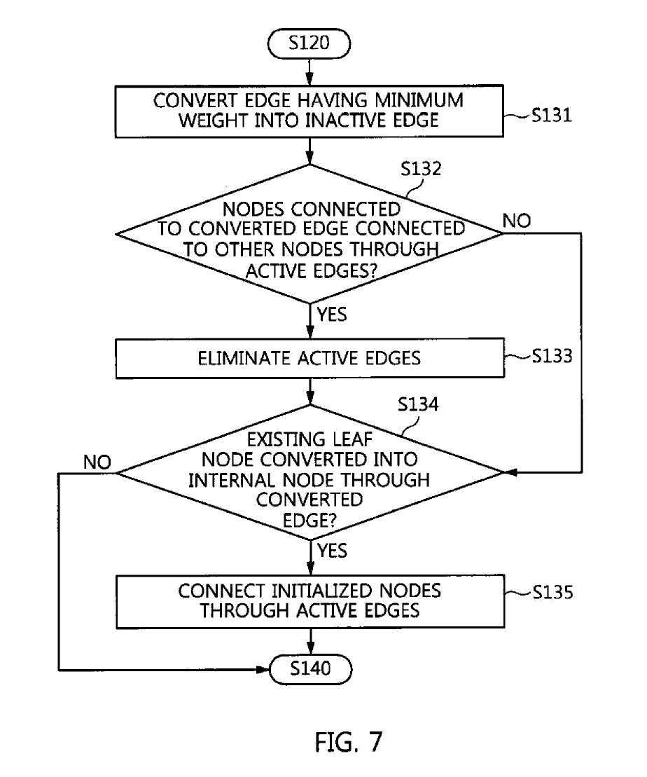

FIG. 6 is a flowchart showing a method for collecting network data traffic according to an embodiment of the present invention, and FIG. 7 is a flowchart showing a tree structure reconstruction method employed in the network data traffic collection method according to an embodiment of the present invention.

Referring to FIG. 6, the network data traffic collection method according to the present invention is a method using the above-described network data traffic collection apparatus, and the same reference numerals in the drawings are recognized to designate the same components.

First, traffic collection units 10 are used as nodes and connection relations between the traffic collection units 10 are used as edges, and then a graph is created in the form of a set of the nodes and the edges at step S100.

Next, the edges of the graph are arranged in ascending order of weights of the edges, and the tree structure of the nodes is initialized at step S110.

Next, an edge having a minimum weight is selected from among the arranged edges at step S120.

Then, the selected edge is converted into an inactive edge and is connected to two nodes, and thus the tree structure is reconstructed at step S130. In this case, if the two nodes connected to the converted inactive edge have been investigated, and they have already been connected to other nodes through active edges, the nodes of the corresponding active edges are eliminated. Further, if an internal node is generated through the converted inactive edge, an additional operation for the internal node is required. In relation to this, a description will be made in detail with reference to FIG. 7. First, the edge having the minimum weight is converted into the inactive edge at step S131. It is determined whether nodes connected to the converted edge are connected to other nodes through active edges at step S132. In this case, if two nodes are connected to other nodes through active edges, the active edges are eliminated at step S133, whereas if two nodes are not connected to other nodes through active edges, it is determined whether an internal node has been generated through the converted inactive edge at step S134. In this case, if an existing leaf node is converted into the internal node, the initialized nodes are connected to each other through active edges at step S135, thus reconstructing the tree structure. This operation is repeated until all of the nodes are included in the reconstructed tree structure, and a monitoring tree, generated as a result of the repetition, may include circulation, and thus the monitoring tree is finally changed to a tree shape by a minimal spanning tree algorithm. Meanwhile, when an existing leaf node is not converted into an internal node, the tree structure is reconstructed without a separate procedure.

Next, the minimal spanning tree algorithm is applied to the reconstructed tree structure at step S140.

Then, a leaf node and a leaf edge are eliminated from the tree structure to which the minimal spanning tree algorithm has been applied, and then a monitoring tree for providing a traffic collection route that minimizes the total weight of edges is generated at step S150.

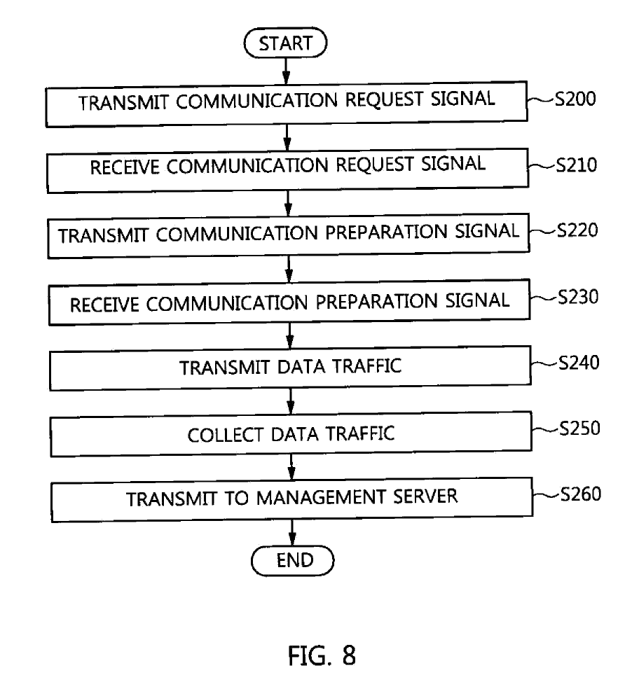

FIG. 8 is a flowchart showing a communication method employed in the network data traffic collection method according to an embodiment of the present invention.

Referring to FIG. 8, the first traffic collection unit 170 transmits a communication request signal to the second traffic collection unit 180 at step S200. Next, after the second traffic collection unit 180 receives the communication request signal at step S210, it generates a communication preparation signal indicating that it collects data traffic, and transmits the communication preparation signal to the first traffic collection unit 170 at step S220. Next, after the first traffic collection unit 170 receives the communication preparation signal at step S230, it transmits collected data traffic to the second traffic collection unit 180 at step S240. Then, the second traffic collection unit 180 collects the received data traffic at step S250. Finally, the second traffic collection unit 180 transmits the collected data traffic to the management server at step S260.

In this way, the apparatus and method for collecting network data traffic according to the present invention collect data traffic by configuring a monitoring tree having a minimal weight without requiring an additional hardware device in a mesh network based on existing smart meters, so that data traffic can be safely and promptly transferred to an intrusion detection system located a long distance away without causing data overlapping, thus improving efficiency and reliability of the intrusion detection system.

Further, the present invention can dynamically configure a mesh network based on smart meters in various forms, so that an external attacker cannot perceive a procedure for collecting data traffic, thus improving the security of an intrusion detection system.

As described above, although preferred embodiments of the present invention have been described, the present invention may be modified in various forms, and it should be understood that those skilled in the art can implement various modifications and changes without departing from the accompanying claims of the present invention.

1. An apparatus for collecting network data traffic, comprising:
a graph creation unit for creating a graph in a form of a set of nodes and edges by using traffic collection units on a network as the nodes and using connection relations between the traffic collection units as the edges;
an initialization unit for arranging the edges of the graph in ascending order of weights of the edges and initializing a tree structure of the nodes;
an edge selection unit for selecting an edge having a minimum weight from among the arranged edges;
a reconstruction unit for converting the selected edge into an inactive edge, and connecting the inactive edge to two nodes, thus reconstructing the tree structure;
an algorithm application unit for applying a minimal spanning tree algorithm to the reconstructed tree structure; and
a traffic collection route provision unit for eliminating a leaf node and a leaf edge from the tree structure to which the minimal spanning tree algorithm has been applied, and generating a monitoring tree for providing a traffic collection route minimizing a total weight of the edges.

2. The apparatus of claim 1, wherein the weights of the edges are values corresponding to distances between the traffic collection units.

3. The apparatus of claim 1, wherein the reconstruction unit comprises:
a node connection determination unit for determining whether the two nodes are connected to other nodes through active edges;
an edge elimination unit for, if the two nodes are connected to other nodes through the active edges, eliminating the active edges;
a node conversion determination unit for determining whether an existing leaf node has been converted into an internal node due to the edge converted into the inactive edge; and
an edge connection unit for, if the existing leaf node has been converted into the internal node, connecting the initialized nodes through active edges, and then reconstructing the tree structure into a tree structure having a maximum number of leaf edges.

4. The apparatus of claim 3, wherein the reconstruction unit reconstructs the tree structure until all of the nodes are included in the tree structure.

5. The apparatus of claim 3, wherein the traffic collection units are classified into a first traffic collection unit corresponding to a leaf node of the tree structure and not belonging to the monitoring tree, and a second traffic collection unit corresponding to an internal node of the tree structure and belonging to the monitoring tree.

6. The apparatus of claim 5, wherein the total weight of the edges does not include a weight of the first traffic collection unit.

7. The apparatus of claim 5, wherein the total weight of the edges includes only a weight of the second traffic collection unit.

8. The apparatus of claim 5, wherein the second traffic collection unit receives a communication request signal from the first traffic collection unit, collects data traffic, and transmits the data traffic to a management server through the traffic collection route.

9. The apparatus of claim 8, wherein the first traffic collection unit comprises:
a communication request transmission unit for transmitting the communication request signal to the second traffic collection unit;
a communication preparation unit for receiving, a communication preparation signal from the second traffic collection unit; and
a first traffic transmission unit for transmitting collected data traffic to the second traffic collection unit.

10. The apparatus of claim 8, wherein the second traffic collection unit comprises:
a communication request reception unit for receiving the communication request signal from the first traffic collection unit;
a communication preparation transmission unit for transmitting the communication preparation signal to the first traffic collection unit;
a traffic reception unit for receiving the data traffic from the first traffic collection unit; and
a second traffic transmission unit for collecting the received data traffic and transmitting the data traffic to the management server through the traffic collection route.

11. The apparatus of claim 1, wherein each of the traffic collection unit includes a plurality of smart meters.

12. The apparatus of claim 10, wherein the management server is implemented as an intrusion detection server for analyzing the received data traffic and detecting an abnormal action.

13. A method for collecting network data traffic, comprising:
creating, by a graph creation unit, a graph in a form of a set of nodes and edges by using traffic collection units on a network as the nodes and using connection relations between the traffic collection units as the edges;
arranging, by an initialization unit, the edges of the graph in ascending order of weights of the edges and initializing a tree structure of the nodes;
selecting, by an edge selection unit, an edge having a minimum weight from among the arranged edges;
converting, by a reconstruction unit, the selected edge into an inactive edge, and connecting the inactive edge to two nodes, thus reconstructing the tree structure;
applying, by an algorithm application unit, a minimal spanning free algorithm to the reconstructed tree structure; and
eliminating, by a traffic collection route provision unit, a leaf node and a leaf edge from the tree structure to which the minimal spanning tree algorithm has been applied, and generating a monitoring tree for providing a traffic collection route minimizing a total weight of the edges.

14. The method of claim 13, wherein the weights of the edges are values corresponding to distances between the traffic collection units.

15. The method of claim 13, wherein reconstructing the tree structure comprises:
determining whether the two nodes are connected to other nodes through active edges;
if the two nodes are connected to other nodes through the active edges, eliminating the active edges;
determining whether an existing leaf node has been converted into an internal node due to the edge converted into the inactive edge; and
if the existing leaf node has been converted into the internal node, connecting the initialized nodes through active edges, and then reconstructing the tree structure into a tree structure having a maximum number of leaf edges.

16. The method of claim 15, wherein reconstructing the tree structure is repeated until all of the nodes are included in the tree structure, thus reconstructing the tree structure.

17. The method of claim 13, further comprising, after generating the monitoring tree:
transmitting, by a first traffic collection unit, a communication request signal to a second traffic collection unit;
receiving, by the second traffic collection unit, the communication request signal;
transmitting, by the second traffic collection unit, a communication preparation signal to the first traffic collection unit;
receiving, by the first traffic collection unit, the communication preparation signal;
transmitting, by the first traffic collection unit, collected data traffic to the second traffic collection unit; and
transmitting, by the second traffic collection unit, the received data traffic to a management server.

18. The method of claim 17, wherein the first traffic collection unit includes traffic collection units corresponding to leaf nodes of the tree structure and not belonging to the monitoring tree, and the second traffic collection unit includes traffic collection units corresponding to internal nodes of the tree structure and belonging to the monitoring tree.

19. The method of claim 17, wherein the total weight of the edges does not include a weight of the first traffic collection unit, and includes only a weight of the second traffic collection unit.
